(19) United States
(12) Patent Application Publication
(10) Pub. No.: US 2021/0150914 A1
(43) Pub. Date: May 20, 2021

(54) FLIGHT CONTROL APPARATUS

(71) Applicant: NTT DOCOMO, INC., Tokyo (JP)

(72) Inventors: Takefumi YAMADA, Tokyo (JP); Ken KOUMOTO, Tokyo (JP); Hidetoshi EBARA, Tokyo (JP); Youhei OONO, Toyko (JP); Yuichiro SEGAWA, Tokyo (JP); Yukiko NAKAMURA, Toyko (JP)

(73) Assignee: NTT DOCOMO, INC., Tokyo (JP)

(21) Appl. No.: 16/623,554

(22) PCT Filed: Jul. 11, 2018
(86) PCT No.: PCT/JP2018/026165

§ 371 Date: Dec. 17, 2019

(30) Foreign Application Priority Data
Sep. 15, 2017 (JP) 2017-177928

(51) Int. Cl. G08G 5/00

(52) U.S. Cl. CPC G08G 5/0039; G08G 5/0047; G08G 5/0021; G08G 5/0034

(57) ABSTRACT

A flight control unit includes an acquisition unit that acquires a flight plan in which first flight conditions are described, by performing communication with a server apparatus. A state judging unit judges a state of the communication. A condition determination unit determines a second flight condition if the judged communication state is a predetermined state. A flight control unit controls flight of an air vehicle based on the determined second flight condition and at least one of the first flight conditions.

### TECHNICAL FIELD

The present invention relates to a technique for controlling flight of air vehicles.

### BACKGROUND ART

Techniques for controlling flight of air vehicles are known. For example, Japanese Patent Application No. JP 2017-65297A discloses that if, in a manual control mode, the speed or attitude of an air vehicle is excessive, it is judged that the air vehicle is in a state in which it is required to avoid danger, the manual operation is disabled, and the air vehicle is piloted automatically. Japanese Patent Application No. 2017-7588A discloses that if a control program running on a flight control apparatus is locked or runs away due to noise or a bug, and a drive apparatus goes out of control, the drive apparatus will be switched from being controlled by the flight control apparatus in accordance with an instruction operation of an operator, to being autonomously controlled by an autonomous flight apparatus irrespective of an instruction operation of the operator.

### SUMMARY

Unmanned air vehicles such as drones encompass an air vehicle that can fly according to a predetermined flight plan without being steered by a person. During the flight of the air vehicle, the flight plan may be updated in accordance with an instruction of operation management, which is transmitted from a server apparatus that manages operation of the air vehicle. However, if the wireless connection between the air vehicle and the server apparatus is poor, there may be a case where an instruction made by the server apparatus is not received, or a case where even if an instruction is received, the most recent state of the air vehicle is not reflected in the instruction. In such a case, the air vehicle may not be able to fly safely based only on the flight plan.

The present invention aims to realize safer flight control according to a communication state with a server apparatus.

According to the present invention, a flight control apparatus is provided that includes: an acquisition unit configured to acquire a flight plan in which first flight conditions are described, by performing communication with a server apparatus; a state judging unit configured to judge a state of the communication; a condition determination unit configured to determine a second flight condition if the judged communication state is a predetermined state; and a flight control unit configured to control flight of an air vehicle, based on the determined second flight condition and at least one of the first flight conditions.

The condition determination unit may determine the second flight condition if the communication state judged while the air vehicle flies deviating from the flight plan is the predetermined state.

The condition determination unit may determine the second flight condition if the judged communication state is the predetermined state and the predetermined state has continued for a predetermined time period.

The predetermined state may include a disconnected state in which the communication is disconnected, and a delayed state in which the communication is delayed, and the predetermined time period may be different between a case where the judged communication state is the disconnected state and a case where the judged communication state is the delayed state.

The acquisition unit may acquire an update instruction to update the flight plan from the server apparatus, by performing the communication, the predetermined state may include a delayed state in which the communication is delayed, and the flight control apparatus may further include an update unit that is configured to update the flight plan in accordance with the acquired update instruction if the judged communication state is a state other than the predetermined state, and that is configured not to reflect the update instruction in the flight plan if the judged communication state is the delayed state.

The flight plan may include a waypoint, a destination point, and a path, and the condition determination unit may determine a new path directed toward the destination point via the waypoint.

The flight plan may include a destination point and a path, and the condition determination unit may determine a new path that returns to a position included in the path and then is directed toward the destination point.

The flight plan may include a destination point and a path, the acquisition unit may acquire state information, which indicates communication states in a plurality of airspaces, and the condition determination unit may determine a new path that is directed toward the destination point via, of the plurality of airspaces, an airspace in which the communication state indicated by the state information is a state other than the predetermined state.

The flight control unit may perform switching between first flight control, which follows the first flight conditions, and second flight control, which follows the second flight condition and at least one of the first flight conditions, according to the judged communication state.

According to the present invention, it is possible to realize safer flight control according to a communication state with a server apparatus.

### BRIEF DESCRIPTION OF DRAWINGS

FIG. 1 is a diagram showing an example of a configuration of flight control system 1, in accordance with the present invention.

FIG. 2 is a diagram showing an example of outer appearance of air vehicle 10, in accordance with the present invention.

FIG. 3 is a diagram showing a hardware configuration of air vehicle 10, in accordance with the present invention.

FIG. 4 is a diagram showing a hardware configuration of server apparatus 20, in accordance with the present invention.

FIG. 5 is a diagram showing an example of a functional configuration of flight control system 1, in accordance with the present invention.

FIG. 6 is a sequence chart showing an example of an operation of flight control system 1, in accordance with the present invention.

FIG. 7 is a diagram showing an example of flight plan 121, in accordance with the present invention.

FIG. 8 is a diagram showing an example of an airspace, in accordance with the present invention.

FIG. 9 is a diagram showing an example of flight path R1, in accordance with the present invention.

FIG. 10 is a diagram showing an example of flight control according to a communication state, in accordance with the present invention.

FIG. 11 is a flowchart showing flight control of air vehicle 10, in accordance with the present invention.

### DETAILED DESCRIPTION

Configuration

FIG. 1 is a diagram showing an example of a configuration of flight control system 1. Flight control system 1 is a system for controlling flight of air vehicles 10. Flight control system 1 includes multiple air vehicles 10 and server apparatus 20.

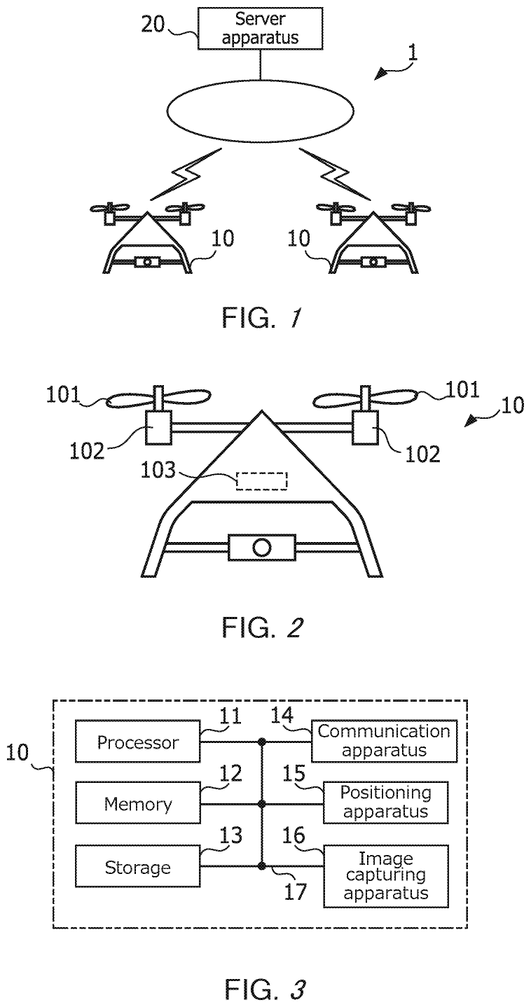

FIG. 2 is a diagram showing an example of the outer appearance of air vehicle 10. Air vehicle 10 is an unmanned aerial vehicle that can autonomously fly without being steered by a person. Air vehicle 10 is a drone, for example. Air vehicle 10 is provided with propellers 101, drive apparatuses 102, and battery 103.

Each propeller 101 rotates about a shaft. As a result of propellers 101 rotating, air vehicle 10 flies. Drive apparatuses 102 supply power to propellers 101 so that they rotate. Drive apparatuses 102 are motors, for example. Drive apparatuses 102 may be directly connected to propellers 101, or may be connected to propellers 101 via transmission mechanisms for transmitting power of drive apparatuses 102 to propellers 101. Battery 103 supplies electric power to the components of air vehicle 10 including drive apparatuses 102.

FIG. 3 is a diagram showing a hardware configuration of air vehicle 10. Air vehicle 10 may also be physically configured as a computer device that includes processor 11, memory 12, storage 13, communication apparatus 14, positioning apparatus 15, image capturing apparatus 16, bus 17, and the like. Note that, in the following description, the term “apparatus” may be read as a circuit, a device, a unit, or the like.

Processor 11 activates, for example, an operating system to control the entire computer. Processor 11 may also be constituted by a central processing unit (CPU) that includes an interface with peripheral apparatuses, a control apparatus, an arithmetic apparatus, a register, and the like.

Furthermore, processor 11 reads a program (program code), a software module, or data onto memory 12 from storage 13 and/or communication apparatus 14, and executes various types of processing based thereon. As the program, a program for causing the computer to execute at least part of an operation of air vehicle 10 is used. The various types of processing that are executed in air vehicle 10 may be executed by one processor 11, or may be executed by two or more processors 11 at the same time or successively. One or more chips may also be mounted on processor 11. Note that the program may also be transmitted from a network via a telecommunication line.

Memory 12 is a computer-readable recording medium, and may also be constituted by, for example, at least one of a read only memory (ROM), an erasable programmable ROM (EPROM), an electrically erasable programmable ROM (EEPROM), and a random access memory (RAM). Memory 12 may also be referred to as a register, a cache, a main memory (main storage unit), or the like. Memory 12 can store a program (program code), a software module, and the like that can be executed to perform a flight control method according to an embodiment of the present invention.

Storage 13 is a computer-readable recording medium, and may also be constituted by, for example, at least one of an optical disk such as a compact disc ROM (CD-ROM), a hard disc drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disc, and a magnetic strip. Storage 13 may also be referred to as an auxiliary storage unit.

Communication apparatus 14 is hardware (a transmitting and receiving device) for performing communication with a computer via a wired network and/or a wireless network, and is also referred to as, for example, a network device, a network controller, a network card, a communication module, or the like.

Positioning apparatus 15 measures the three-dimensional position of air vehicle 10. Positioning apparatus 15 is, for example, a global positioning system (GPS) receiver, and measures the current position of air vehicle 10 based on GPS signals received from a plurality of satellites.

Image capturing apparatus 16 captures an image of the surrounding area of air vehicle 10. Image capturing apparatus 16 is a camera for example, and performs image capturing by using an optical system to form an image on an imaging element. Image capturing apparatus 16 captures, for example, an image of a predetermined range forward of air vehicle 10. Note, however, that the direction in which image capturing apparatus 16 captures an image is not limited to the direction forward of air vehicle 10, and may also be a direction upward, downward, or backward of air vehicle 10. Furthermore, the image capture direction may also be changed, for example, by rotation of a pedestal that supports image capturing apparatus 16.

Furthermore, the apparatuses such as processor 11 and memory 12 are connected to each other via bus 17 for communicating information. Bus 17 may be constituted by a single bus, or may be constituted by buses that are different from each other between the apparatuses.

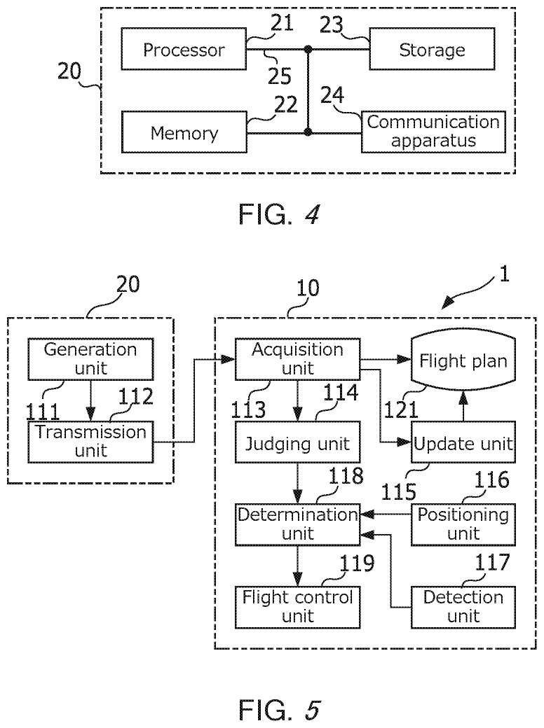

FIG. 4 is a diagram showing a hardware configuration of server apparatus 20. Server apparatus 20 functions to perform operation management with respect to air vehicle 10. The term “operation management” means managing air traffic of air vehicle 10. For example, if air vehicle 10 is an unmanned aerial vehicle such as a drone, the operation management includes setting of a flight airspace of air vehicle 10 and control of a flight path. Note, however, that “operation management” is an idea that can encompass not only management of such an unmanned aerial vehicle but also air traffic management of a manned aircraft, namely, keeping track of and performing notification of the entire airspace in which the manned aircraft flies, for example.

Server apparatus 20 may also be physically constituted by a computer device that includes processor 21, memory 22, storage 23, communication apparatus 24, bus 25, and the like. Processor 21, memory 22, storage 23, communication apparatus 24, and bus 25 are the same as above-described processor 11, memory 12, storage 13, communication apparatus 14, and bus 17, and thus descriptions thereof are omitted.

FIG. 5 is a diagram showing an example of a functional configuration of flight control system 1. Flight control system 1 functions as generation unit 111, transmission unit 112, acquisition unit 113, judging unit 114, update unit 115, positioning unit 116, detection unit 117, determination unit 118, and flight control unit 119. In this example, generation unit 111 and transmission unit 112 are mounted on server apparatus 20. The functions of server apparatus 20 are realized by reading predetermined software (program) onto hardware such as processor 21 or memory 22 so that processor 21 performs calculation, and controlling communication using communication apparatus 24 and reading and/or writing of data with respect to memory 22 and storage 23. On the other hand, acquisition unit 113, judging unit 114, update unit 115, positioning unit 116, detection unit 117, determination unit 118, and flight control unit 119 are mounted on air vehicle 10. The functions of air vehicle 10 are realized by reading predetermined software (program) onto hardware such as processor 11 or memory 12 so that processor 11 performs calculation, and controlling communication using communication apparatus 14 and reading and/or writing of data with respect to memory 12 and storage 13. In this case, air vehicle 10 functions as a flight control apparatus.

Generation unit 111 generates flight plan 121 and an operation management instruction for air vehicle 10. This flight plan 121 means information indicating a flight plan. Flight plan 121 includes first flight conditions. Flight conditions means conditions that air vehicle 10 should follow when it flies. The flight conditions are used in flight control of air vehicle 10. The operation management instruction means a flight-related instruction given to in-flight air vehicle 10. For example, there is a case where it is preferable to change flight plan 121 after air vehicle 10 has started flying, according to the status or environment of air vehicle 10. In this case, an operation management instruction that includes an instruction to update flight plan 121 is generated.

Transmission unit 112 transmits, to air vehicle 10, flight plan 121 and the operation management instruction that were generated by generation unit 111. Acquisition unit 113 communicates with server apparatus 20 to acquire flight plan 121 and the operation management instruction that were transmitted from transmission unit 112.

Judging unit 114 judges a communication state with server apparatus 20. The communication state indicates whether or not communication is possible between air vehicle 10 and server apparatus 20, or speed of communication between air vehicle 10 and server apparatus 20. Update unit 115 updates flight plan 121 based on the operation management instruction received from server apparatus 20.

Positioning unit 116 measures the position of air vehicle 10. Positioning unit 116 is realized by, for example, above-described positioning apparatus 15. Detection unit 117 detects an object that is present within a predetermined range from air vehicle 10. By performing, for example, image recognition processing on an image captured by image capturing apparatus 16, detection unit 117 detects an object present within a predetermined range from air vehicle 10. The object is an obstacle that will hinder flight, such as another air vehicle 10, a bird, a natural object, or a building.

Determination unit 118 determines a second flight condition if the state judged by judging unit 114 is a predetermined state. The predetermined state refers to a state in which, for example, no appropriate operation management instruction is received from server apparatus 20. For example, the predetermined state refers to a state in which communication with server apparatus 20 is disconnected or delayed. Furthermore, determination unit 118 may also determine the second flight condition based on the position measured by positioning unit 116 and the object detected by detection unit 117.

Flight control unit 119 controls the flight of air vehicle 10 based on the first flight conditions described in flight plan 121 or the second flight condition determined by determination unit 118. For example, if the communication state judged by judging unit 114 is the predetermined state, flight control unit 119 may also control the flight of air vehicle 10 based on the second flight condition and at least one of the first flight conditions. Furthermore, flight control unit 119 may also perform switching between first flight control, which follows the first flight conditions described in flight plan 121, and second flight control, which follows the second flight condition and at least one of the first flight conditions, according to the communication state judged by judging unit 114.

Note that, in the following description, if air vehicle 10 is described as the subject of processing, it is meant that the processing is executed specifically by reading predetermined software (program) onto hardware such as processor 11 or memory 12 so that processor 11 performs calculation, and controlling communication using communication apparatus 14 and reading and/or writing of data with respect to memory 12 and storage 13. The same applies to server apparatus 20.

Operation

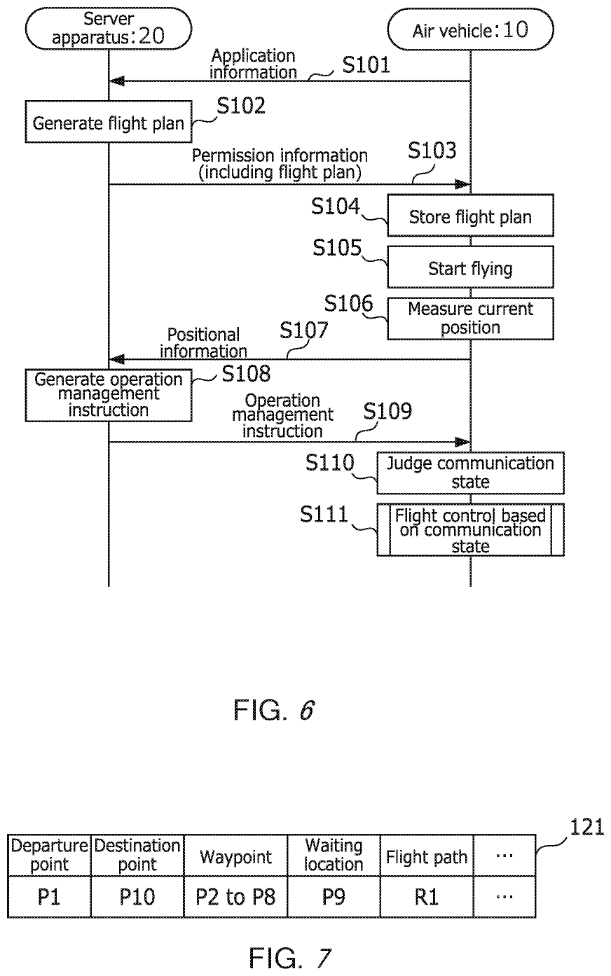

FIG. 6 is a sequence chart showing an example of an operation of flight control system 1. Here, an example will be described in which server apparatus 20 gives an operation management instruction to air vehicle 10 at regular intervals. Processing of step S101 is started before air vehicle 10 flies.

In step S101, air vehicle 10 transmits application information for applying a flight permission. The application information includes, for example, flight conditions such as flight date, a flight path, and a flight altitude.

In step S102, generation unit 111 of server apparatus 20 generates flight plan 121 of air vehicle 10 based on the application information received from air vehicle 10.

FIG. 7 is a diagram showing an example of flight plan 121. Flight plan 121 includes a departure point, a destination point, a waypoint, a waiting location, and a flight path. The departure point is a location from which air vehicle 10 takes off. The destination point is a location set as a destination of the flight of air vehicle 10. The waypoint is a location that air vehicle 10 is to pass through when it flies from the departure point to the destination point. The waiting location is a location at which air vehicle 10 temporarily waits. The flight path is a three-dimensional air route along which air vehicle 10 is to fly.

In this example, flight plan 121 includes departure point P1, destination point P10, waypoints P2 to P8, waiting location P9, and flight path R1. These flight conditions may also be flight conditions included in the application information, or may also be set by server apparatus 20. For example, the flight conditions may also be set based on an attribute of the airspace in which air vehicle 10 is to fly.

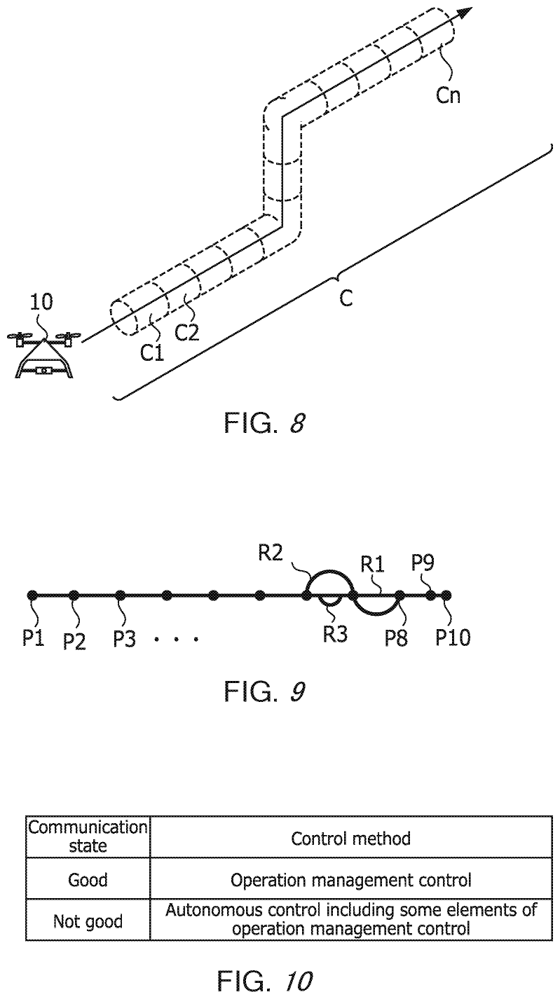

FIG. 8 is a diagram showing an example of an airspace. In this example, the airspace is divided into multiple airspace cells C. Each airspace cell C is a three-dimensional space. Airspace cell C has, for example, a tubular shape. Note, however, that the shape of airspace cells C is not limited to a tubular shape, and may also be a shape other than a tubular shape, such as a prismatic column.

An attribute may also be set for airspace cell C. This attribute includes, for example, a flight direction and an airspace type. If, for example, a flight direction toward north from south is set for airspace cell C1, air vehicle 10 can only fly through airspace cell C1 in this flight direction. The airspace type includes, for example, a common airspace and an exclusive airspace. In a common airspace, multiple air vehicles 10 can fly at the same time. On the other hand, in an exclusive airspace, only one air vehicle 10 can fly at a time. For example, if airspace cell C1 is set as an exclusive airspace and is assigned to one air vehicle 10 from 13:00 to 15:00, another air vehicle 10 cannot pass through airspace cell C1 in this time span. Above-described flight path R1 may also be set in view of such an attribute of airspace cell C.

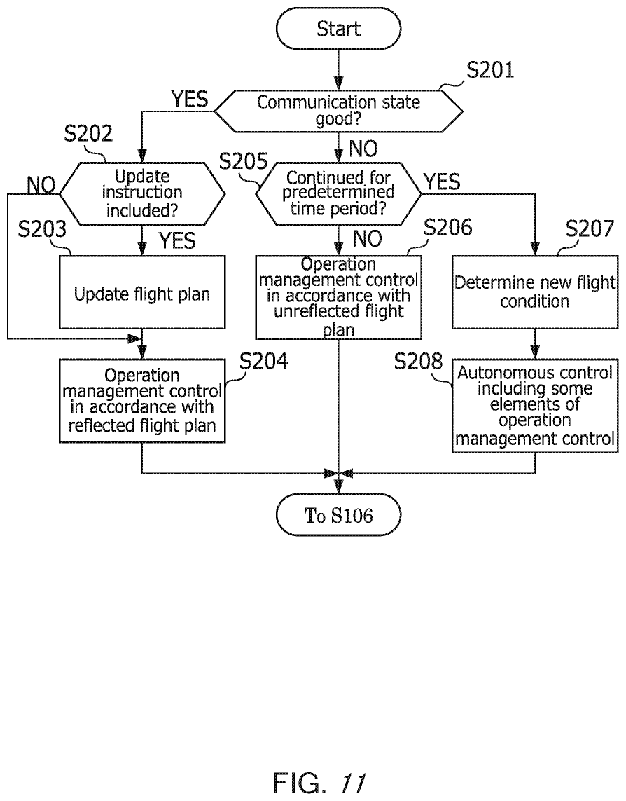

FIG. 9 is a diagram showing an example of flight path R1. Flight path R1 is a path extending from departure point P1 to destination point P10 via waypoints P2 to P8. Also, waiting location P9 is located in the vicinity of destination point P10. When flight path R1 is set, airspace cells C1 to Cn on flight path R1 are assigned to air vehicle 10. Alternatively, flight path R1 itself may also be expressed as successive airspace cells C.

In step S103, transmission unit 112 of server apparatus 20 transmits, to air vehicle 10, permission information for permitting a flight. The permission information includes flight plan 121 generated in step S102. Acquisition unit 113 of air vehicle 10 receives the permission information from the server apparatus 20.

In step S104, air vehicle 10 stores flight plan 121 included in the received permission information in storage 13.

In step S105, air vehicle 10 starts flying in accordance with flight plan 121 stored in storage 13. Specifically, flight control unit 119 controls drive apparatuses 102 so that air vehicle 10 flies along flight path R1 described in flight plan 121. As a result of drive apparatuses 102 performing driving under the control of flight control unit 119, propellers 101 rotate and air vehicle 10 flies.

In step S106, positioning unit 116 of air vehicle 10 measures the current position of air vehicle 10 at predetermined time intervals.

In step S107, air vehicle 10 transmits, to server apparatus 20, positional information indicating the current position measured in step S106. Server apparatus 20 receives the positional information from air vehicle 10. Note, however, that there may be a case where the positional information transmitted from air vehicle 10 does not arrive at server apparatus 20, or a case where the positional information arrives at server apparatus 20 with delay, if, for example, the communication state between air vehicle 10 and server apparatus 20 is poor.

In step S108, generation unit 111 of server apparatus 20 generates, at a predetermined time interval, an operation management instruction based on the position indicated by the received positional information. For example, if air vehicle 10 is instructed to continue to fly in accordance with current flight plan 121, the operation management instruction will include a continuation instruction. On the other hand, if flight plan 121 of air vehicle 10 is to be updated, the operation management instruction will include an update instruction. The update instruction includes update information of flight plan 121. The update information may also be information indicating only update content, or updated flight plan 121. Furthermore, generation unit 111 adds a time stamp indicating the time at which the operation management instruction was generated to the operation management instruction.

In step S109, transmission unit 112 of server apparatus 20 transmits the operation management instruction generated in step S108 to air vehicle 10. Acquisition unit 113 of air vehicle 10 receives the operation management instruction from server apparatus 20. Note, however, that there may be a case where the operation management instruction transmitted from server apparatus 20 does not arrive at air vehicle 10, or a case where the operation management instruction arrives at air vehicle 10 with delay, if for example, the communication state between air vehicle 10 and server apparatus 20 is poor.

In step S110, judging unit 114 of air vehicle 10 judges a communication state with server apparatus 20. This communication state includes a “good” state in which communication is possible without delay, and a “not good” state in which communication is disconnected or delayed. The following will take several examples to describe how to judge a communication state.

For example, judging unit 114 judges the communication state as “not good” if no new operation management instruction has been received from server apparatus 20 even after elapse of a predetermined time period from when the previous operation management instruction was received. On the other hand, judging unit 114 judges the communication state as “good”, if a new operation management instruction has been received from server apparatus 20 before elapse of a predetermined time period from when the previous operation management instruction was received from server apparatus 20. The predetermined time period may also be 10 minutes, if, for example, a predetermined time interval is 10 minutes.

In another example, judging unit 114 judges the communication state as “not good”, if an operation management instruction has been received from server apparatus 20 within a predetermined time period from when the previous operation management instruction was received, but the time indicated by the time stamp added to the received operation management instruction shows a time that is more than a predetermined time period prior to the current time. On the other hand, judging unit 114 judges the communication state as “good” if the time indicated by the time stamp added to the operation management instruction received from server apparatus 20 shows a time that is within a predetermined time period prior to the current time. This predetermined time period is a time period in which an operation management instruction can be regarded as having been transmitted from server apparatus 20 without delay at a predetermined time interval, for example.

In another example, judging unit 114 judges the communication state as “not good” if an operation management instruction has been received from server apparatus 20 within a predetermined time period from when the previous operation management instruction was received, but the received operation management instruction does not have content in which the current position measured in step S106 is reflected. For example, if the operation management instruction includes positional information indicating the current position of air vehicle 10, and the current position indicated by the positional information is different from the current position measured in step S106, the operation management instruction will not have content in which the current position measured in step S106 is reflected, and thus the communication state is judged as “not good”. On the other hand, if the operation management instruction received from server apparatus 20 has content in which the current position measured in step S106 is reflected, judging unit 114 judges the communication state as “good”.

In step S111, flight control unit 119 of air vehicle 10 performs flight control based on the communication state judged in step S110.

FIG. 10 is a diagram showing an example of flight control according to the communication state. If the communication state is “good”, air vehicle 10 flies in accordance with operation management control. The operation management control refers to control of flight in accordance with flight plan 121. The operation management control is an example of the above-described first flight control. On the other hand, if the communication state is “not good”, air vehicle 10 flies in accordance with autonomous control that includes some elements of operation management control. This autonomous control refers to control of flight based on a flight condition that was determined by air vehicle 10 itself irrespective of flight plan 121. The autonomous control including some elements of operation management control is an example of the above-described second flight control. In this manner, air vehicle 10 switches the flight control method according to the communication state with server apparatus 20.

FIG. 11 is a flowchart showing flight control of air vehicle 10. The processing shown in FIG. 11 is executed in above-described step S111.

In step S201, air vehicle 10 judges whether or not the communication state judged in step S110 is “good”. For example, if the communication state is “good” (YES in step S201), the procedure advances to step S202.

In step S202, update unit 115 of air vehicle 10 judges whether or not the operation management instruction received from server apparatus 20 in above-described step S109 includes an instruction to update flight plan 121. If the operation management instruction includes an update instruction (YES in step S202), the procedure advances to step S203.

In step S203, update unit 115 of air vehicle 10 updates flight plan 121 stored in storage 13 in accordance with the update instruction included in the operation management instruction received from server apparatus 20. For example, if update information included in the update instruction is information indicating a change from flight path R1 to flight path R2 shown in FIG. 9, flight path R1 described in flight plan 121 will be changed to flight path R2. At this time, flight path R1 may also be overwritten with flight path R2.

On the other hand, if, in above-described step S202, the operation management instruction received from server apparatus 20 does not include an update instruction (NO in step S202), the procedure advances to step S204 without executing the processing in step S203.

In step S204, flight control unit 119 performs operation management control in accordance with flight plan 121 in which the operation management control received in step S109 is reflected (hereinafter, referred to as “reflected flight plan 121”). Reflected flight plan 121 is flight plan 121 updated in step S203 if the operation management instruction includes an update instruction. On the other hand, if the operation management instruction includes a continuation instruction, reflected flight plan 121 is current flight plan 121 stored in storage 13.

Specifically, flight control unit 119 controls the flight based on all of the flight conditions described in reflected flight plan 121. For example, flight control unit 119 performs flight control so that air vehicle 10 passes through flight path R2 described in flight plan 121. With this flight control, air vehicle 10 flies along flight path R2 to destination point P10 via waypoints P2 to P8. During the operation management control, air vehicle 10 does not fly along a path different from flight path R2. Note, however, that air vehicle 10 may also halt or wait, according to a position measured by positioning unit 116 or an obstacle detected by detection unit 117.

On the other hand, if, in above-described step S201, the judged communication state is “not good” (NO in step S201), the procedure advances to step S205.

In step S205, flight control unit 119 judges whether or not the state in which communication with server apparatus 20 is “not good” has continued for a predetermined time period. The predetermined time period is a time period in which, for example, the flight of air vehicle 10 in accordance with current flight plan 121 can be regarded as not posing a problem. If operation management instructions are transmitted from server apparatus 20 at, for example, a 10-minute interval, the predetermined time period may be 20 minutes. If, for example, a predetermined time period has not elapsed from when the previous operation management instruction was received from server apparatus 20, it will be judged that the state in which the communication with server apparatus 20 is “not good” has not continued for a predetermined time period (NO in step S205). In this case, the procedure advances to step S206.

In step S206, flight control unit 119 performs operation management control in accordance with flight plan 121 in which the operation management control received in step S109 is not reflected (hereinafter, referred to as “unreflected flight plan 121”). For example, in a state in which the communication with server apparatus 20 is delayed, an operation management instruction will be received from server apparatus 20 even if the communication state is “not good”. However, in this case, there may be a possibility that the recent position of air vehicle 10 will not be reflected in the operation management instruction, and the content of the operation management instruction will not be appropriate. Accordingly, even if the operation management instruction includes an update instruction, update unit 115 will not update flight plan 121 in accordance with the update instruction. In this case, unreflected flight plan 121 is flight plan 121 that was not updated in accordance with the update instruction included in the operation management instruction. Note that, in this case, the operation management instruction received from server apparatus 20 may also be discarded.

Specifically, flight control unit 119 controls the flight in accordance with all of the flight conditions described in unreflected flight plan 121. For example, the flight control unit 119 performs flight control so that air vehicle 10 passes through flight path R1 described in flight plan 121. With this flight control, air vehicle 10 flies along flight path R1 to destination point P10 via waypoints P2 to P8. During the operation management control, air vehicle 10 does not fly along a path different from flight path R1. Note, however, that air vehicle 10 may also halt or wait, according to a position measured by positioning unit 116 or an obstacle detected by detection unit 117.

On the other hand, in above-described step S205, if, for example, a predetermined time period has elapsed from when the previous operation management instruction was received from server apparatus 20, it is judged that the state in which the communication with server apparatus 20 is “not good” has continued for a predetermined time period (YES in step S205). In this case, the procedure advances to step S207. In other words, if the communication state with server apparatus 20 is “not good” and this state has continued for a predetermined time period, the procedure advances to step S207.

In step S207, determination unit 118 disables at least one of the flight conditions described in flight plan 121, and determines a new flight condition based on a position measured by positioning unit 116 and an object detected by detection unit 117. For example, determination unit 118 disables flight path R1 described in flight plan 121. Then, determination unit 118 determines a new flight path R3 extending from the position measured by positioning unit 116 toward destination point P10 via waypoints P2 to P8 described in flight plan 121, while avoiding collision with the object detected by detection unit 117. As shown in FIG. 9, flight path R3 basically differs at least partially from flight path R1 described in flight plan 121. Note, however, that flight path R3 may also be the same as flight path R1, in some situations.

In step S208, flight control unit 119 performs autonomous control that includes some elements of operation management control. Specifically, flight control unit 119 controls the flight based on enabled flight conditions described in flight plan 121 and the new flight condition determined in step S207. If, for example, flight path R1 is disabled in above-described step S207, the enabled flight conditions are flight conditions other than flight path R1, namely, departure point P1, destination point P10, waypoints P2 to P8, and waiting location P9. For example, flight control unit 119 performs flight control so that air vehicle 10 passes through new flight path R3 determined in step S207. With this flight control, air vehicle 10 flies, along flight path R3, to destination point P10 via waypoints P2 to P8.

After the processing in step S204, S206, or S208 is complete, the procedure returns to above-described step S106, and the processing of step S106 and onwards is repeated.

Furthermore, there may be cases where air vehicle 10 deviates from flight path R1 described in flight plan 121 due to a cause such as weather. By comparing, for example, the position measured in above-described step S106 with flight path R1, it is judged whether or not air vehicle 10 has deviated from flight path R1. If air vehicle 10 has deviated from flight path R1 described in flight plan 121, the processing of above-described step S110 and onwards may also be executed. Note, however, that, in this case, if it is judged in above-described step S201 that the communication state is not “good” (NO in step S201), the processing may also advance to step S207 without performing the processing in above-described step S205. In this case, the processing in above-described steps S205 and S206 is not performed. In other words, if the communication state judged while air vehicle 10 flies deviating from flight plan 121 is “not good”, a new flight condition may also be immediately determined, and autonomous control that includes some elements of the above-described operation management control may also be performed.

According to the above-described embodiment, air vehicle 10 can fly irrespective of an operation management instruction, even if the communication state with server apparatus 20 is “not good” and an operation management instruction is not received from server device 20 or an operation management instruction has been received but the content of the operation management instruction is inappropriate. Furthermore, in this case, if autonomous control that includes some elements of operation management control is performed, air vehicle 10 can determine, by itself, the flight condition according to the status and environment of air vehicle 10. In this case, even if, for example, there is an obstacle in airspace cell C, the risk of collision with the obstacle will be low, and thus the flight safety will be higher than in a case where operation management control is performed. According to the above-described embodiment, thus, it is possible to perform safer flight control if the communication state between the air vehicle 10 and server apparatus 20 is “not good”.

Furthermore, in the autonomous control that includes some elements of operation management control, some flight conditions described in flight plan 121 are enabled, and thus it is possible to cause air vehicle 10 to fly in accordance with the operation management control to some extent. Accordingly, the risk of collision between air vehicles 10 is lower than in a case where air vehicles 10 fly completely with autonomous control, and thus the flight safety is enhanced.

If the communication state with server apparatus 20 is “good”, air vehicle 10 flies in accordance with flight plan 121 received from server apparatus 20. In this case, since air vehicle 10 does not need to perform autonomous control, the burden of processing of air vehicle 10 is mitigated and the power consumption is also suppressed.

Furthermore, also when air vehicle 10 has deviated from flight plan 121, air vehicle 10 can fly irrespective of an operation management instruction if the communication state with server apparatus 20 is “not good” and an operation management instruction is not received from server apparatus 20 or an operation management instruction has been received but content of the operation management instruction is inappropriate. Accordingly, air vehicle 10 does not need to continuously wait for an operation management instruction from server apparatus 20 or does not need to fly in accordance with an inappropriate operation management instruction received from server apparatus 20.

Modifications

The present invention is not limited to the above-described embodiment. The above-described embodiment may also be modified in the following manner. Furthermore, two or more modifications below may also be executed in combination.

The method for determining flight path R3 by determination unit 118 is not limited to the above-described embodiment. For example, flight path R3 may also be determined based on the previous flight path R1 or communication state between airspace cells C.

For example, determination unit 118 may also determine flight path R3, which returns to a position on flight path R1 and then is directed toward destination point P10. This position may also be, for example, a position on flight path R1 that is closest to the current position of air vehicle 10. Note, however, that any position may be used as long as it is a position on flight path R1. As a result of flight path R3 being determined in this manner, air vehicle 10 can return to original flight path R1 even when it is flying deviating from flight path R1.

In another example, determination unit 118 may also determine flight path R3 directed toward destination point P10 via airspace cells C in which the communication state is good. In this case, a communication map that indicates the communication states of airspace cells C is transmitted in advance from server apparatus 20 to air vehicle 10. The communication map is an example of state information that indicates communication states. Determination unit 118 may also specify airspace cell C in which the communication state is good, based on the communication map. Airspace cell C in which the communication state is good is, for example, airspace cell C in which communication with server apparatus 20 is possible or airspace cell C in which the speed of communication with server apparatus 20 is equal to or higher than a predetermined speed. In another example, commonly, the communication state is better in airspace cell C whose altitude is low than airspace cell C whose altitude is high. Accordingly, determination unit 118 may also specify airspace cell C whose altitude is equal to or lower than a predetermined altitude, as airspace cell C in which the communication state is good.

In the above-described embodiment, if the communication state is “not good”, judging unit 114 of air vehicle 10 may also judge whether it is a disconnected state in which communication is disconnected, or a delayed state in which communication is delayed. For example, judging unit 114 judges that it is a disconnected state if a new operation management instruction has not been received from server apparatus 20 even after elapse of a predetermined time period from when the previous operation management instruction was received from server apparatus 20. On the other hand, judging unit 114 judges that it is a delayed state if an operation management instruction has been received from server apparatus 20 within a predetermined time period from when the previous operation management instruction was received, but the time indicated by a time stamp added to the received operation management instruction is a time that is more than a predetermined time period prior to the current time, or the content of the received operation management instruction is not content in which the current position measured in step S106 is reflected.

Furthermore, the predetermined time period used in judging in step S205 may be different between a case where the communication state with server apparatus 20 is a disconnected state and a case where it is a delayed state. For example, if it is judged by judging unit 114 that it is a disconnected state, the predetermined time period used in judging in step S205 may be shortened. This is because when the communication state with server apparatus 20 is a disconnected state, there is a low likelihood that even if air vehicle 10 waits while flying in accordance with the previous flight plan 121, the communication state will become good and an appropriate operation management instruction will be obtained from server apparatus 20, and thus it is thought that it is preferable to immediately advance the procedure to the processing in steps S207 and S208.

In another example, if it is judged by judging unit 114 that it is a delayed state, the predetermined time period used in judging in step S205 may also be extended. This is because, when the communication state with server apparatus 20 is a delayed state, there is a high likelihood that if air vehicle 10 waits while flying in accordance with previous flight plan 121, the communication state will be improved and it will be possible to obtain an appropriate operation management instruction from server apparatus 20, and thus it is thought that it is preferable to wait for an operation management instruction from server apparatus 20 without immediately advancing to the processing in steps S207 and S208.

Furthermore, if the communication state with server apparatus 20 is a delayed state, part of flight plan 121 stored in storage 13 may also be updated in accordance with an operation management instruction received from server apparatus 20 in above-described step S109. For example, a case is considered in which the operation management instruction received from server apparatus 20 includes an update instruction to update destination point P10 and flight path R1 that are described in flight plan 121 to a new destination point and a new flight path. In this case, if the communication state with server apparatus 20 is a delayed state, update unit 115 of air vehicle 10 may also update, out of destination point P10 and flight path R1 described in flight plan 121, only destination point P10 to a new destination point. In this case, flight path R1 is not updated. This is because when the communication state with server apparatus 20 is a delayed state, there is a high likelihood that the current position of air vehicle 10 is not reflected in the operation management instruction received from server apparatus 20. Accordingly, it is thought that it is inappropriate to update the flight condition, such as a flight path, that is closely-related to the current position of air vehicle 10, while it is thought that it is appropriate to update the flight condition, such as a destination point, that is remotely-related to the current position of air vehicle 10.

In the above-described embodiment, it is also possible that server apparatus 20 may also give an operation management instruction only if air vehicle 10 has deviated from flight plan 121, instead of giving an operation management instruction during flight of air vehicle 10 in accordance with flight plan 121. In this case, the processing of above-described step S108 and onwards may also be performed, only if air vehicle 10 has deviated from flight plan 121.

The flight conditions included in flight plan 121 are not limited to the examples described in the above-described embodiment. For example, flight plan 121 may also include only some of a departure point, a destination point, a waypoint, a waiting location, and a flight path. In another example, flight plan 121 may also include another flight condition regarding a flight distance, or another flight condition regarding a flight time or a flight speed. The flight condition regarding the flight time may also be, for example, a scheduled departure time, a scheduled arrival time, or a waypoint passage time. The flight condition regarding the flight speed may also be, for example, a flight speed or an average flight speed.

For example, flight plan 121 does not need to include a flight path. In this case, when operation management control is performed, air vehicle 10 determines a flight path directed toward destination point P10 via waypoints P2 to P8 described in flight plan 121, and flies along the determined flight path. Furthermore, when performing autonomous control that includes some elements of operation management control, air vehicle 10 may also disable the waypoint, out of the destination point and the waypoint that are described in flight plan 121, and determine a new waypoint and a new flight path. This flight path is determined so as to be directed toward destination point P10 described in flight plan 121, for example. Furthermore, for example, a spot on this flight path is determined as the waypoint.

In another example, flight plan 121 may also further include a flight speed, a scheduled departure time, and a scheduled arrival time. In this case, when performing autonomous control that includes some elements of operation management control, air vehicle 10 may also disable the flight speed, out of the flight speed, the scheduled departure time, and the scheduled arrival time that are described in flight plan 121, and determine a new flight speed. This flight speed is determined such that, for example, air vehicle 10, if having departed at a scheduled departure time, will arrive at a destination point at a scheduled arrival time.

In short, the flight conditions described in flight plan 121 may also be divided into a first class and a second class. Also, the flight conditions of the first class are always enabled irrespective of the communication state with the server apparatus 20, and the flight conditions of the second class will be disabled if the communication state with server apparatus 20 is a predetermined state, and may also be determined by air vehicle 10. For example, the flight conditions of the second class may also be more detailed flight conditions than the flight conditions of the first class. In another example, the flight conditions of the second class may also be flight conditions that are obtained based on the flight conditions of the first class.

In the above-described embodiment, the method for measuring the position of air vehicle 10 is not limited to a method using a GPS. The position of air vehicle 10 may also be measured by a method in which a GPS is not used.

In the above-described embodiment, the method for detecting an object that is present within a predetermined range from air vehicle 10 is not limited to a method using an image captured by image capturing apparatus 16. For example, a radar may also be used to detect an object that is present within a predetermined range from air vehicle 10.

In the above-described embodiment, air vehicle 10 may also have at least some of the functions of server apparatus 20. Similarly, server apparatus 20 may also have at least some of the functions of air vehicle 10.

The present invention may also be provided as a flight control method that includes processing steps that are executed in flight control system 1. Furthermore, the present invention may also be provided as a program that is executed in air vehicle 10 or server apparatus 20.

The block diagram of FIG. 5 shows blocks per functional units. These functional blocks (configuration units) are realized by an arbitrary combination of hardware and/or software. Furthermore, means for realizing the functional blocks is not particularly limited. In other words, the functional blocks may also be realized by one physically and/or logically coupled apparatus, or a plurality of apparatuses obtained by directly and/or indirectly (for example, in a wired and/or wireless manner) connecting two or more apparatuses that are physically and/or logically separated.

The hardware configuration of air vehicle 10 or server apparatus 20 may also be configured to include one or more apparatuses shown in FIG. 3 or 4, or may also be configured not to include some apparatuses. Furthermore, air vehicle 10 or server apparatus 20 may also be configured to include hardware such as a microprocessor, a DSP (Digital Signal Processor), an ASIC (Application Specific Integrated Circuit), a PLD (Programmable Logic Device), or an FPGA (Field Programmable Gate Array), and some or all of the functional blocks of air vehicle 10 or server apparatus 20 may also be realized by the hardware. For example, processor 11 or 21 may also be implemented by at least one of these pieces of hardware.

Notification of information is not limited to the aspects/embodiments explained in the present description, and may also be performed by another method. For example, notification of information may also be performed by physical layer signaling (for example, downlink control information (DCI) or uplink control information (UCI)), higher-level layer signaling (for example, radio resource control (RRC) signaling, medium access control (MAC) signaling, broadcast information (master information block (MIB) or system information block (SIB))), and other signals, or a combination thereof. Furthermore, RRC signaling may also be referred to as an RRC message, and may also be, for example, an RRC Connection Setup message, an RRC Connection Reconfiguration) message, or the like.

The aspects/embodiments explained in the present description may also be applied to a system using Long Term Evolution (LTE), LTE-Advanced (LTE-A), SUPER3G, IMT-Advanced, 4G, 5G, Future Radio Access (FRA), W-CDMA (registered trademark), GSM (registered trademark), CDMA2000, Ultra Mobile Broadband (UMB), IEEE802.11 (Wi-Fi), IEEE802.16 (WiMAX), IEEE802.20, Ultra-Wide Band (UWB), Bluetooth (registered trademark) or another appropriate system, and/or a next-generation system expanded based on them.

The orders of the processing procedure, sequence, flowchart, and the like of the aspects/embodiments described in the present description may be changed unless they contradict each other. For example, the methods explained in the present description show various step elements in an exemplified order, and are not limited to the shown specific order.

Information and the like may be output from a higher-level layer (or a lower-level layer) to a lower-level layer (or a higher-level layer). Information and the like may also be input/output via a plurality of network nodes.

Input/output information and the like may also be stored in a specific location (for example, a memory), or may also be managed in a management table. Information and the like to be input/output may be overwritten, updated, or added. Output information and the like may also be deleted. Input information and the like may also be transmitted to another apparatus.

Judging may also be conducted using a value expressed by a single bit (0 or 1) or a truth-value (Boolean: true or false), or by comparing numerical values (for example, comparing a value with a predetermined value).

The aspects/embodiments explained in the present description may also be used alone or in combination, or may also be switched when they are implemented. Furthermore, notification of predetermined information (for example, notification of “being X”) is not limited to being performed explicitly, and may also be performed implicitly (for example, notification of the predetermined information is not performed).

Software should be broadly interpreted to mean an instruction, an instruction set, a code, a code segment, a program code, a program, a sub program, a software module, an application, a software application, a software package, a routine, a subroutine, an object, an executable file, an execution thread, a procedure, a function and the like, regardless of whether it is referred to as software, firmware, middleware, a microcode, a hardware description language, or another name.

Furthermore, software, an instruction, and the like may also be transmitted/received via a transmission medium. For example, if software is transmitted from a web site, a server, or another remote source, using a wired technology such as a coaxial cable, an optical fiber cable, a twist pair, and a digital subscriber line (DSL), and/or a wireless technology such as infrared light, a radio wave, and a microwave, the definition of the transmission medium will include the wired technology and/or the wireless technology.

Information, signals, and the like described in the present description may also be expressed using any of various different technologies. For example, data, an instruction, a command, information, a signal, a bit, a symbol, a chip, and the like that may be mentioned over the entire description above may also be expressed by an electric voltage, an electric current, an electromagnetic wave, a magnetic field or a magnetic particle, an optical field or a photon, or an arbitrary combination thereof.

Note that the terms described in the present description and/or the terms needed for understanding the present description may also be replaced by terms that have the same or similar meaning. For example, a channel and/or a symbol may also be a signal. Furthermore, a signal may also be a message. Furthermore, a component carrier (CC) may also be referred to as a carrier frequency, a cell, or the like.

The terms “system” and “network” used in the present description can be used in an interchangeable manner.

Furthermore, the information and the parameters explained in the present description may also be expressed by absolute values, relative values from a predetermined value, or another type of corresponding information. For example, a radio resource may also be one indicated by an index.

The names used for the above-described parameters are in no way limiting. Furthermore, there may be a case where formulae and the like using these parameters are different from those explicitly disclosed in the present description. Various channels (such as, for example, a PUCCH and a PDCCH) and information elements (such as, for example, a TPC) can be identified by any suitable name, and thus various names assigned to these various channels and information elements are no way limiting.

The term “determining” used in the present description may include various types of operations. The term “determining” can include a case where judging, calculating, computing, processing, deriving, investigating, looking up (for example, looking up a table, a data base, or another data structure), or ascertaining is regarded as “determining”. Furthermore, the term “determining” can include a case where receiving (for example, receiving information), transmitting (for example, transmitting information), inputting, outputting, or accessing (for example, accessing data in the memory) is regarded as “determining”. Furthermore, the term “determining” can include a case where resolving, selecting, choosing, establishing, or comparing is regarded as “determining”. In other words, the term “determining” can include a case where some operation is regarded as “determining”.

The terms “connected” and “coupled”, or any form thereof mean any type of direct or indirect connection or coupling between two or more elements, and may include a case where one or more intermediate elements are present between two elements that are “connected” or “coupled” to each other. The elements may be subjected to physical coupling or connection, logical coupling or connection, or a combination of physical and logical coupling/connection. Two elements, when used in the present description, can be thought of as being “connected” or “coupled” to each other by using one or more wires, cables, and/or printed electric connections, and using electromagnetic energy such as electromagnetic energy having a wavelength in a radio frequency range, a micro wave range, and a light (both visible light and invisible light) range, as some non-limiting and incomprehensive examples.

The term “based on” used in the present description does not mean “based on only”, unless otherwise noted. In other words, the term “based on” means both terms “based on only” and “based on at least”.

Any reference to the elements using designations such as “first” and “second” used in the present description does not limit, in general, the amount or order thereof. These nominal signs can be used in the present description as a convenient method for distinguishing between two or more elements. Accordingly, reference to first and second elements does not mean that only two elements can be used here, or that the first element should precede the second element somehow.

The “means” in the configurations of the above-described apparatuses may be replaced by “units”, “circuit”, “device”, or the like.

The terms “including”, “comprising”, and any form thereof are intended to be comprehensive as long as they are used in the present description or the claims, similar to the term “being provided with”. Furthermore, the term “or” used in the present description or the claims is intended not to be exclusive OR.

In the entirety of the present disclosure, when articles are added through translation, for example, as “a”, “an”, and “the” in English, these articles also denote the plural form unless it is clear otherwise from the context.

While the present invention has been described in detail, it would be obvious to those skilled in the art that the present invention is not limited to the embodiments explained in the present description. The present invention can be implemented as corrected and modified aspects without departing from the spirit and scope of the present invention that are defined by the description of the claims. Accordingly, the present description aims to illustrate examples and is not intended to restrict the present invention in any way.

### REFERENCE SIGNS LIST

1 Flight control system
10 Air vehicle
20 Server apparatus
111 Generation unit
112 Transmission unit
113 Acquisition unit,
114 Judging unit
115 Update unit
116 Positioning unit,
117 Detection unit
118 Determination unit
119 Flight control unit

What is claimed is:

1-9. (canceled)

10. A flight control apparatus comprising:
an acquisition unit configured to acquire a flight plan in which first flight conditions are described, by performing communication with a server apparatus;
a state judging unit configured to judge a state of the communication;
a condition determination unit configured to determine a second flight condition if the judged communication state is a predetermined state; and
a flight control unit configured to control flight of an air vehicle based on the determined second flight condition and at least one of the first flight conditions.

11. The flight control apparatus according to claim 10,
wherein the condition determination unit determines the second flight condition if the communication state judged while the air vehicle flies deviating from the flight plan is the predetermined state.

12. The flight control apparatus according to claim 10,
wherein the condition determination unit determines the second flight condition if the judged communication state is the predetermined state and the predetermined state has continued for a predetermined time period.

13. The flight control apparatus according to claim 11,
wherein the condition determination unit determines the second flight condition if the judged communication state is the predetermined state and the predetermined state has continued for a predetermined time period.

14. The flight control apparatus according to claim 12,
wherein the predetermined state includes a disconnected state in which the communication is disconnected, and a delayed state in which the communication is delayed, and the predetermined time period is different between a case where the judged communication state is the disconnected state and a case where the judged communication state is the delayed state.

15. The flight control apparatus according to claim 10,
wherein the acquisition unit acquires an update instruction to update the flight plan from the server apparatus, by performing the communication,
the predetermined state includes a delayed state in which the communication is delayed, and
the flight control apparatus further comprises an update unit that is configured to update the flight plan in accordance with the acquired update instruction if the judged communication state is a state other than the predetermined state, and that is configured not to reflect the update instruction in the flight plan if the judged communication state is the delayed state.

16. The flight control apparatus according to claim 10,
wherein the flight plan includes a waypoint, a destination point, and a path, and
the condition determination unit determines a new path directed toward the destination point via the waypoint.

17. The flight control apparatus according to claim 10,
wherein the flight plan includes a destination point and a path, and
the condition determination unit determines a new path that returns to a position included in the path and then is directed toward the destination point.

18. The flight control apparatus according to claim 10,
wherein the flight plan includes a destination point and a path,
the acquisition unit acquires state information, which indicates communication states in a plurality of airspaces, and
the condition determination unit determines a new path that is directed toward the destination point via, of the plurality of airspaces, an airspace in which the communication state indicated by the state information is a state other than the predetermined state.

19. The flight control apparatus according to claim 10,
wherein the flight control unit performs switching between first flight control, which follows the first flight conditions, and second flight control, which follows the second flight condition and at least one of the first flight conditions, according to the judged communication state.
